(19) United States
(12) Patent Application Publication
(10) Pub. No.: US 2020/0238375 A1
(43) Pub. Date: Jul. 30, 2020

(54) METHOD FOR PREPARING POWDERS FOR A COLD SPRAY PROCESS, AND POWDERS THEREFOR

(71) Applicant: National Research Council of Canada, Ottawa (CA)

(72) Inventors: Dominique POIRIER, Boucherville (CA); Paul-Émile MONGEON, Laval (CA); Yannig THOMAS, Montréal (CA); Eric IRISSOU, Longueuil (CA)

(73) Assignee: National Research Council of Canada, Ottawa, ON (CA)

(21) Appl. No.: 16/632,567

(22) PCT Filed: Jul. 20, 2018
(86) PCT No.: PCT/IB2018/055439

§ 371 Date: Jan. 21, 2020

Related U.S. Application Data
(60) Provisional application No. 62/535,533, filed on Jul. 21, 2017.

(51) Int. Cl. B22F 1/00; C23C 24/04

(52) U.S. Cl. CPC B22F 1/0096; B22F 1/0085; B33Y 70/00; C23C 24/04; B22F 1/0014

(57) ABSTRACT

A method for enabling cold spray of steels, particularly transformation hardenable steels including tool steels, has been made possible by: heat treating steel powder while agitating the powder to limit agglomeration and particle growth; cooling it slowly enough to avoid retransformation hardening; and protecting the powder from cold working or retransformation hardening until cold sprayed. Surprisingly the softening, as well as the agglomerated morphology of powders, has been found to allow for deposition of steel powders. Furthermore, the cooling has been found to be possible within 8 hour heat treatments, and high density, and reasonably high deposition efficiencies have been achieved. Water- and gas-atomized starting powders have been treated and cold sprayed.

### TECHNICAL FIELD

The present subject matter relates to cold spray powders, and more particularly to a powder consisting of a hard material for cold spraying, and how to prepare them.

### BACKGROUND

Cold spray (also called kinetic spray, supersonic particle deposition, dynamic metallization, kinetic metallization, or cold gas dynamic spray) is a coating deposition process of increasing importance because it is a solid state deposition process that permits coatings to be formed without melting feedstock, and thereby reduces oxidation and other reactions. Due to the compressive residual stresses created during spraying, very thick coatings can be produced and even freeforms, making cold spray applicable as an additive manufacturing technology. During cold spray deposition, solid powders are accelerated in a carrier gas toward a substrate. Upon impact with the substrate, the powders undergo plastic deformation and adhere to the surface of the substrate, provided that a critical velocity is met.

It is understood that the predominant bonding mechanisms in cold spraying include adiabatic shear instability and mechanical interlocking, which occur at the particle substrate interface only if the particles meet or exceed a critical velocity. If the particle velocity is too low, a coating will not be produced. Beyond the critical velocity, increasing further powder velocity yields, up to a certain point, higher deposition efficiency, higher coating density and better mechanical properties. The advantages of fully solid powder deposition generally are worth the costs to accelerate these powders, as cold spray reduces oxidation and other undesired chemical reactions of the coating material, as well as alteration of its microstructure, which can adversely impact material properties.

An important factor in determining the suitability of powder materials for cold spraying is their deformation properties, as this directly affects the critical velocity. Materials with low mechanical strength and low melting points, for example zinc and copper alloys, are good materials for cold spray processes. However, materials with higher strength, such as steels that undergo martensitic phase transformation, resist deformation and many such materials cannot currently be deposited using existing cold spray equipment. Improving deformability of such hard material powders, to make them suitable for cold spraying, would open the door to applications not yet possible with cold spray, such as injection mold manufacturing, part reinforcement, structural repair of aircraft parts, and additive manufacturing of tool and die, to name a few. Furthermore, treating materials may advantageously increase a range of spray conditions under which they can be cold sprayed, provide for better deposition efficiency, or produce coatings having better properties.

To cold spray harder (lower deformation) powders, it is known to adjust cold spray processes to maximize particle in-flight velocity, for example, by increasing process gas temperature and pressure, by using helium as the process gas instead of lower cost and more readily available gases such as air and nitrogen, and by optimizing nozzle design.

Other known approaches to enable deposition of harder powders include increasing the temperature of the powder and/or the substrate by external sources, for example using a laser, or by adjusting cold spray conditions to maximize surface and/or particle temperature (e.g. increasing process gas temperature or reducing traverse speed), or varying the morphology and porosity of feedstock powder.

For certain materials, however, these approaches are not sufficient to enable powder deposition. Consequently, several cold spray applications that would provide significant advantages over existing technologies are currently not possible. There is particularly a need in the art for processes for modifying hard steel material powders, for example tool steels, to make them suitable, or more suitable, for cold spray deposition. The ability to cold spray additive manufacture hardened tool steel parts would be an exciting advance in the cold spray arts, opening the possibility of cold spray additive manufacture of new parts and application spaces unheard of.

It is known that loosely agglomerated powders, and porous powders, have lower particle hardness than solid powders of the same material. For example, dense and thick WC—Co coatings can be produced by cold spraying of loosely agglomerated and porous feedstock powders. (See Sonoda, T., Kuwashima, T., Saito, T., Sato, K., Furukawa, H., Kitamura, J., Ito, D., Super hard WC cermet coating by low pressure cold spray based on optimization of powder properties, (2013) Proceedings of the International Thermal Spray Conference—ITSC 2013, Busan, Korea, pp. 241-245; and also Gao P.-H., Li, Y.-G., Li, C.-J., Yang, O.-J., Li, C.-X., Influence of powder porous structure on the deposition behavior of cold-sprayed WC-12Co coatings, (2008) Journal of Thermal Spray Technology, 17 (5-6), pp. 741-749).

Porosity enables deformation, and also reduces particle density which advantageously decreases inertia and allows for faster acceleration in a given carrier gas stream. To obtain optimal coating deposition, agglomerate porosity and/or cohesion levels must be carefully adjusted to allow deformation at particle impact while preventing particle fragmentation.

It is also known in powder metallurgy in general that powders composed of some metal alloys are heat treatable. Heat treatable alloys, such as tool steels, can be softened through the use of an annealing heat treatment to facilitate powder deformation in subsequent shaping. Heat treatment of suitable alloy powders is used in conventional powder metallurgy such as in the press and sintering processing of powder where the softening of the metal powder permits better compaction of the heat treatable alloy. It will be noted that press and sintering is a fairly remote metal powder forming technique from cold spray, in that an entirely different set of mechanisms are used to produce parts. In particular, non-porous particles of larger size are preferred.

European patent application EP 2218529 describes a method for producing a metal alloy powder or a metal powder encapsulated by a layer of a metal alloy by reacting under agitation and heat a powder and/or granulate made of metal or metal alloy with a diffusion alloying metal powder comprising tin and/or zinc. In this method, the agitation is conducted to avoid or at least significantly reduce caking or powder sintering during heat treatment with the intent of obtaining finely dispersed powders having similar morphology as the starting powders. The means disclosed for diffusion bonding are a gas-tight rotating retort furnace, a fluidized bed, a tumbler, a vibrator or a static stirrer. The purpose of EP 2218529 is to adjust powder composition, and not to adjust (lower) powder mechanical properties through microstructure tailoring. The action of creating an alloy through diffusion alloying is expected to harden the powder rather than soften it, which is the opposite of what is desired to improve cold sprayability of a powder.

Accordingly, there remains a need in the art for techniques for reducing critical velocity of hard powders, without chemically altering the powders, to expand the range of feedstock powders that are amenable to cold spray deposition.

### SUMMARY

The following summary is intended to introduce the reader to the more detailed description that follows, and not to define or limit the claimed subject matter.

According to a first aspect of the present subject matter, a method is provided for preparing a feedstock for cold spray deposition. The method comprises the steps of: obtaining a feedstock powder having a first size distribution, the powder consisting of a transformation hardenable steel, or a metal matrix composition of a transformation hardenable steel; heat treating the feedstock powder to a softening temperature of the transformation hardenable steel and holding the feedstock powder at the softening temperature while agitating the powder for a time period effective to soften the material and to partially sinter the powder to form powder agglomerates, while avoiding powder caking; cooling the powder agglomerates at a rate sufficiently slow to avoid re-transformation hardening of the material to produce softened powder agglomerates of a second size distribution coarser than the first distribution, the second size distribution having a nominal size less than 150 μm and more than 1 μm, and protecting the softened powder agglomerates from hardening until cold spray. Protecting may comprise preventing cold working, or re-transformation hardening of the softened powder agglomerates. To avoid cold working, it is desirable to avoid exposing particles of the softened powder agglomerates to a stress exceeding a yield stress of the softened agglomerated particles.

The process may further involve sieving the cooled powder agglomerates to produce softened powder agglomerates having a second size distribution adjusted to cold sprayed equipment requirements. The process may further involve soft grinding to partially de-agglomerate the coarser cooled powder agglomerates to increase a yield of the feedstock. Soft grinding may involve mixing the cooled powder agglomerates in a container (possibly in a flowing medium) such that agglomerated particles of the cooled powder agglomerates do not strike any grinding medium bodies harder than the softened powder, and a mean energy of collision is not sufficient to break the agglomerated particles away from sinter necks of the agglomerated particles, such as in a V blender with no hard grinding medium.

The first size distribution of the feedstock powder may have 90% of the volume fraction of the particles below 70 μm and 10% of the volume fraction of particles finer than 20 μm. It may, for example, have 90% of the volume fraction of the particles below 70 μm and at least 10% of the volume fraction of particles below 8 μm, or have 90% of the volume fraction of the particles below 70 μm and at least 20% of the volume fraction of particles below 8 μm.

In some embodiments of the present invention, the heat treatment agglomerates small particles such that the second size distribution has less than half of the volume fraction of particles below 8 μm in the first size distribution.

In some embodiments of the present invention, the powder feedstock is gas atomized or water atomized powder.

In some embodiments of the present invention, the feedstock powder is a tool steel. For example, the tool steel may be H13 tool steel. If so, the softening temperature may be between approximately 845° and 900° C. In other embodiments the tool steel is P20 tool steel. In such cases, the softening temperature may be between 750° and 800° C., more preferably from 760° and 790° C.

In either case, the cooling rate may be slow enough to prevent the formation of martensite.

In some embodiments of the present invention, the heat treating step is performed in an inert atmosphere.

In some embodiments of the present invention, the method further comprises the step of applying the softened powder agglomerations to a substrate by a cold spray process to form a surface layer. The method may also further include the steps of evaluating an integrity of the surface layer by physical testing and/or microscopic inspection; and if the integrity of the surface layer is considered to be unsatisfactory, adjusting at least one of the softening temperature, the time period, or the cooling rate, and repeating the method steps until the integrity of the surface later is considered to be satisfactory.

In accordance with another aspect of the present subject matter, there is provided a heat treated feedstock powder for cold spray deposition comprising particles having a size distribution with a nominal size less than 150 μm and more than 1 μm, composed of a transformation hardenable steel, or a metal matrix composition of a transformation hardenable steel, and having a Vickers microhardness less than 70% of the hardness of the same grade of steel if it were fully transformation hardened.

In some embodiments of the present invention, the steel is a tool steel, a low alloy strength steel, or a martensitic stainless steel, for example, H13, P20 or D2 tool steels.

In some embodiments of the present invention, the feedstock powder has a spheroidised carbide microstructure associated with softened transformation hardenable steels.

In some embodiments of the present invention, the feedstock powder comprises particles of a transformation hardenable grade of steel having a Vickers mircohardness less than 50% of the hardness of the same grade of steel if it were fully transformation hardened.

In some embodiments of the present invention, the feedstock powder has a morphology of sintered subparticles. The subparticles have a distribution of sizes, including at least 10% of the volume fraction of particles consisting of subparticles finer than 20 μm, or more preferably 8 μm.

### BRIEF DESCRIPTION OF DRAWINGS

In order that the claimed subject matter may be more fully understood, reference will be made to the accompanying drawings, in which:

FIG. 1 is a flow chart illustrating principle steps in a method of the present invention;

FIG. 2 is a schematic illustration of a particle of a powder in accordance with the present invention;

FIG. 3 is a graph showing the temperatures of the heat treatment of H13 powders as a function of time, in an example of the present invention;

FIG. 4 is a graph showing the effect of heat treatment on the compressibility of H13 powders, in an example of the present invention;

FIG. 5 is a graph showing the particle size distributions of heat treated (HT) and as-received coarse, lot A (+10-45 μm) and fine, lot B (−16 μm) H13 powders;

FIGS. 6A-D is a series of SEM micrographs showing the microstructure of as-received coarse (lot A) (FIG. 6A and FIG. 6B), and fine (lot B) (FIG. 6C) H13 powders, as well as heat treated fine (lot B) H13 powders (FIG. 6D);

FIGS. 7A-D is a series of SEM micrographs showing as-received coarse (lot A) powders, (FIG. 7A at 250× magnification), heat-treated coarse (lot A) powders (FIG. 7B at 250× magnification), as-received fine (lot B) powders, (FIG. 7C at 1000× magnification) and heat-treated fine (lot B) powders (FIG. 7D at 1000× magnification);

FIGS. 8A-C is a series of micrographs of the cold sprayed H13 coatings produced by cold spray of: as-received coarse (lot A) powder (FIG. 8A), heat-treated coarse (lot A) powder (FIG. 8B) and heat-treated fine (lot B) powder (FIG. 6C);

FIG. 9 is a graph showing two cooling rates following heat treatment of the H13 powders;

FIGS. 10A-C is a series of micrographs of fine (lot B) H13 powders, at 10,000× magnification, as-received (FIG. 8A), cooled after heat treatment at a rate of 22° C./hr (FIG. 8B), and cooled after heat treatment at a rate of 350° C./hr (FIG. 8C);

FIGS. 11A-D is a series of micrographs showing deposited heat-treated fine (lot B) H13 powders cooled at a rate of 22° C./hr (FIGS. 11A,B), and cooled at a rate of 350° C./hr (FIGS. 11C,D) at two magnifications;

FIG. 12 is a graph showing the size particle distributions of as-received and heat treated (HT) water atomized H13 powders;

FIGS. 13A,B is a series of micrographs of water atomized H13 powders, at 1,000× magnification, as-received (FIG. 13A) and after heat treatment (FIG. 13B);

FIGS. 14A,B is a series of SEM micrographs of cold sprayed coatings produced with as-received water atomized H13 powders (FIG. 14A) and heat treated water atomized H13 powders (FIG. 14B);

FIG. 15 is a graph showing the temperatures of the heat treatment of P20 powders as a function of time;

FIG. 16 is a graph showing the size particle distributions of heat treated (HT) and as received P20 powders;

FIGS. 17A,B is a series of micrographs showing the agglomeration of P20 powders following heat treatment; and

FIG. 18 is a SEM micrograph of a cold sprayed coating produced with heat treated P20 powders.

### DETAILED DESCRIPTION OF EMBODIMENTS

In the following description, specific details are set out to provide examples of the claimed subject matter. However, the embodiments described below are not intended to define or limit the claimed subject matter. It will be apparent to those skilled in the art that many variations of the specific embodiments may be possible within the scope of the claimed subject matter.

It has been found that, surprisingly, when heat treatment conditions, particle size distribution and agitation are properly selected, commercially available tool steel powders may be made suitable for cold spraying.

FIG. 1 is a flowchart illustrating principal steps in a method of the present invention. At step 10 a transformation hardenable steel bearing powder is provided. While we have demonstrated in the examples below the ability to turn several hardened tool steels into cold sprayable powders, it is believed that a full range of transformation hardenable steels, including tool steels, low alloy strength steels, and martensitic stainless steels, are amenable to softening by this method, as well as metal matrix composites of such steels, such as boron nitride reinforced steels, if suitably heat treated, at least with powders bearing sufficient relative amounts of the steel. (Ferritic, austenitic and duplex stainless steels, and maraging steels are believed not suited, as these are known not to be transformation hardenable.) The provided powders have a particle size distribution, preferably including some (i.e. 30-90 vol. %) larger (i.e. 10-80 μm, more preferably 10-50 μm, more preferably 10-30 μm) particles and some (i.e. 80-5 vol. %, more preferably 60-10 vol. %) finer (i.e. 20-0.3 μm, more preferably 10-0.5 μm, more preferably 8-1 μm) particles, and the larger powders are at least 10% larger than the finer powders. The distribution may be bi-modal.

It has been found that powders with particles having a morphology of sintered spherical sub-particles is not necessary for cold sprayability. Specifically the provided powders may be produced by any powder metallurgy processes, including gas and water atomized and grinding/comminuted powder producing methods.

At step 12, the powders are heat treated while the powder is agitated, at a temperature regimen where annealing and partial sintering of the powder occur. It will be understood that agitation during the heating treatment may be carried out in a rotary furnace as well as any other agitation system that avoids caking, for example, a fluidized bed, a tumbler, a vibrator, or a static stirrer. The heat treatment is performed in an atmosphere that limits oxidation. The atmosphere may be inert (preferably in a noble or other non-reactive gas), although a vacuum could, in principle be used. Furthermore a slightly reducing atmosphere (e.g. inclusion of a small fraction of hydrogen into the atmosphere) can be chosen to scavenge oxygen and improve a purity of the powder, as is well known in the art of high temperature heat treatment of ferrous powders.

When heat treatment conditions are properly selected, agitation during the heat treatment prevents the powder from caking, by reducing the sintering and agglomeration.

After the heat treatment step the powder is gradually cooled (step 14). A fast quenching of the powders is expected to transformation harden and lose advantages of the heat treatment. It is desirable that the heat treatment includes a controlled cooling step to prevent the formation of martensite and minimize precipitation hardening effect. Selection of the cooling rate to ensure powder properties, and maintain desired cost-efficiency is a trade-off that can be selected by those of ordinary skill. Surprisingly even relatively high cooling rates of 350° C./hr have been found to be satisfactory for some steel.

This produces agglomerated softened powders which may be suitable for cold spray as is. If control over agglomeration is not satisfactory, or the duration of the heat treatment required for adequate softening of the steel results in particles growing to dimensions that are unsuitable for cold spray feedstock equipment, at least sieving of the agglomerated softened powders would be called for (step 16). Furthermore, to improve a yield, a soft grinding of the agglomerated softened powders may be performed, to partially de-agglomerate the agglomerated softened powders. By de-agglomerating, some sinter necks joining subparticles of particles of the agglomerated softened powders are fractured, but with minimal plastic deformation of the agglomerated softened powders, to avoid cold working and powder hardening. Soft grinding allows for such de-agglomeration by generally colliding the particles with other particles or possibly grinding media bodies (balls, rods, etc.) that are softer (in terms of inertia and hardness) than the particles themselves. An example of this is the use of a V-blender (or other similar low shear blending equipment) with no grinding medium, set at a low enough speed to reduce collision energy to less than sufficient to break the agglomerated particles away from sinter necks of the agglomerated particles. The higher the energy of the collisions, the more cold working of the particles is produced that might lead to hardening of powder surface. The lower energy of collisions, the fewer de-agglomerations may be produced.

From the time the agglomerated softened powders are cooled until they are cold sprayed (step 18), or sold for such a purpose, they are protected from hardening. By avoiding hard crushing or hard grinding, the powder material will not be hardened by cold working. Screening and soft grinding is required to adjust the final size of the obtained agglomerates to cold sprayed equipment requirements.

Applicant has found surprisingly that such treatment leads to softened powder agglomerates that can be cold spray deposited. It is believed that the combination of softening of the steel, morphology of the sintered powder, and consequent porosity allows for pseudo deformation and increasing particle acceleration (and impact velocity) during cold spray to cumulatively achieve reliable deposition. The resulting agglomerated powders have been shown to be amenable to cold spray deposition, unlike their untreated powders.

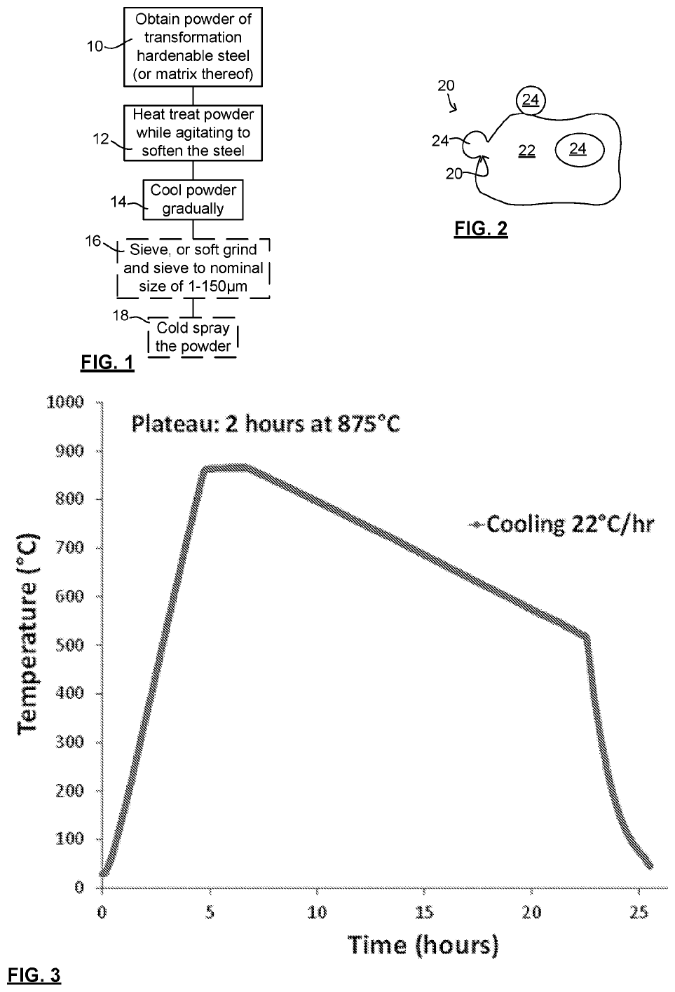

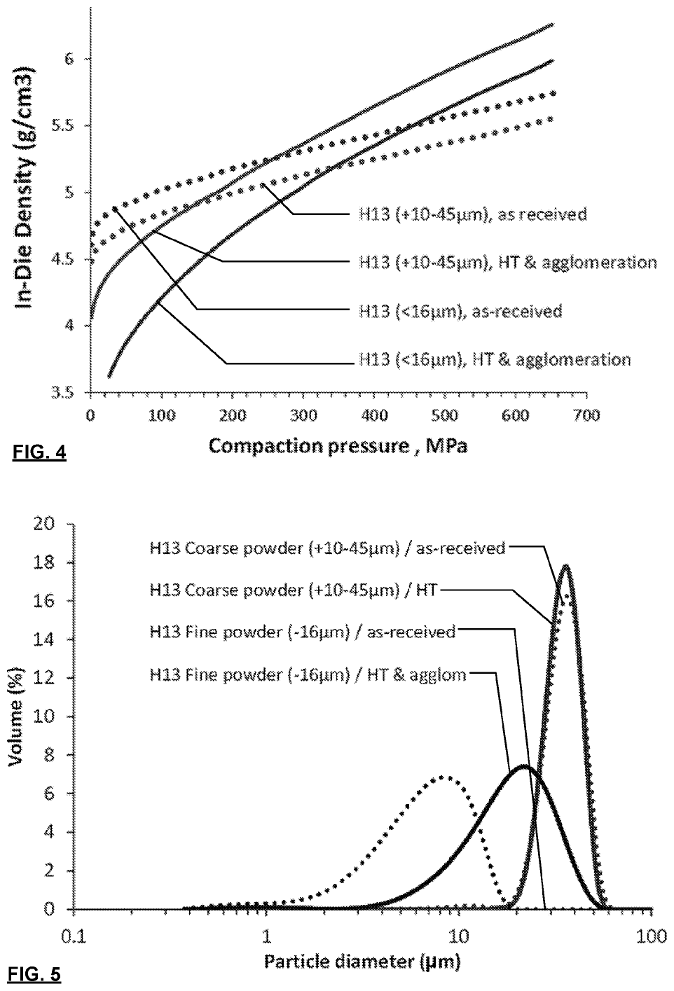

FIG. 2 is a schematic illustration of a typical particle 20 of a powder produced from the method at step 14 or 16. The morphology of the particle 20 is an agglomeration of one or more (in this case one) larger diameter (i.e. 10-80 μm, more preferably 10-70 μm, more preferably 10-30 μm) subparticle 22, agglomerated with finer (i.e. 20-0.3 μm, more preferably 10-0.5 μm, more preferably 8-1 μm) subparticles 24. Typically the larger particles are fewer in number than the finer subparticles, but represent the greatest volume fraction. The larger subparticle 22 is shown with a higher angularity than the finer subparticles 24, although this is not essential, and a shape of the subparticles is generally not critical. While there is advantage to particles having larger surface area to volume ratio, in terms of acceleration within a carrier stream, even highly spherical subparticles 22/24 have been shown to work well. The finer subparticles 24 are typically more than 10 vol. % of the particle, and may be 15 vol % to 30 vol. %.

It should be noted herein that the term ‘agglomeration’, for example in the phrase “softened powder agglomerates” corresponds to partial sintering of particles and not to soft agglomeration, for instance, by Van der Waals forces between particles, which can be seen on some as-received powders in the micrograph images herein below. Such weakly joined agglomerated powders are expected to be de-agglomerated during powder handling or in the cold spray jet and are not suited for cold spraying.

Both the larger subparticles 22 and the finer subparticles 24 are composed of, and preferably composed primarily of, the transformation hardenable steels described hereinabove, or a metal matrix composite having the steel as a metal matrix. The larger subparticles 22 and finer subparticles 24 may be of a same steel.

### Example 1: H13 Tool Steel Powder

Mold and die makers primarily use tool steels such as H13, P20 and D2 to benefit from their high surface hardness, high strength, thermal properties, etc. Cold spray additive manufacturing of tool steel would open opportunities in this industry by reducing cost, risks and turnaround time and improving capabilities by conformal cooling and new materials in the design. Applicant's co-pending U.S. Provisional 62/699,063 specifically teaches forming hollow structures within cold spray additive manufactured parts formed of the heat treated tool steel of the present invention, inter alia.

Steels used for tools can have different compositions, but have in common their high hardness, as necessary to resist deformation and wear. This high hardness strongly limits cold spray deposition. Preliminary trials with nitrogen carrier gas failed to produce any coating with commercial H13 powders. No report in the literature of cold sprayed tool steels has been found.

Methodology:

Both coarse, lot A (+10-45 μm) and fine, lot B (−16 μm) H13 gas atomized tool steel powders were subject to a heat treatment. The heat treatment caused annealing (softening) and agglomeration with partial sintering of the powders. The powder treatment was carried out in a rotating tube furnace comprising a 4-inch quartz tube (MTI Corporation Model OFT1200X) under the following conditions: 2.5 rpm, nitrogen atmosphere, 0.6-1 kg/batch. During the annealing step the powders were soaked at 875° C. for 2 hours, then subsequently cooled at a controlled rate of about 22° C./hr until the temperature reached about 500° C. and then allowed to cool freely to room temperature (see FIG. 3 for temperature regimen). The heat treated (HT) powders were sieved in a 45 μm sieve of nominal opening and subsequently were cold sprayed using the same parameters (Plasma Giken PCS1000, Tᵢ(N2)=950° C., Pᵢ(N2)=4.9 MPa, Stand-off=45 mm, robot speed=300 mm/s).

Powder Deformation Behavior and Hardness:

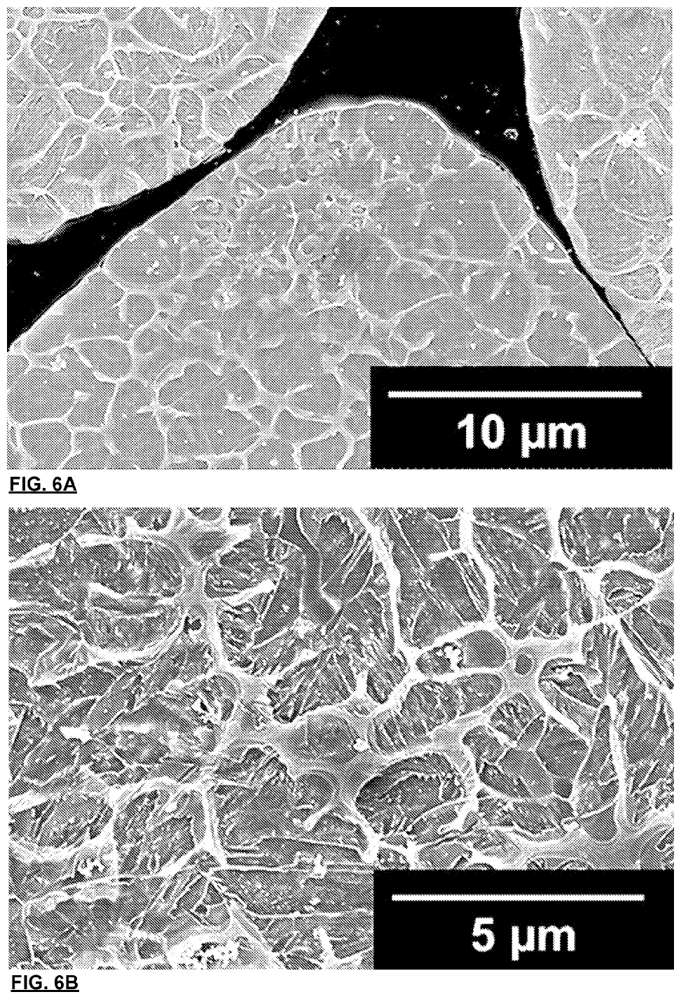

Referring to FIG. 4, initial testing was carried out to measure the effect of the heat treatment on the compressibility of the H13 powders by compaction of these powders on the instrumented press called the Powder Testing Centre (model PTC-03DT) manufactured by KZK Powder Technologies Corp. This apparatus consist of an instrumented cylindrical die operating in a single action mode. The applied and transmitted pressures through the compact are measured by two independent load cells. The measure of the displacement of the mobile (lower) punch is converted to give the average density of the part by assuming a rigid behaviour of the die of 9.525 mm diameter. The heat treated (HT) H13 powders (solid lines) show an increasing in-die density with compaction pressure, whereas the as-received powders (dashed lines) show far slower density gains with increasing compaction pressure. The HT powders also show a lower initial density (presumably due to agglomeration) but a higher density at high pressures, conforming with expectations of softer materials. The as-received powders, once compacted, did not hold together, and demonstrated springback and delamination, but the HT powders were deformable and sound compacts were produced.

Hardness of these powders were measured using nanoindentor G200 from Nanoinstruments (MTS) at a charge of 3 gf and using a Berkovitch tip. As shown in Table 1 below, the hardness of the HT powders is substantially lower than the as-received powders, and was even slightly lower than that of the annealed H13 bulk. These results show that the heat treatment conditions are adequate and the resulting powders are as soft as can be expected for this steel.

TABLE 1

| H13 powders | Nano Hardness (GPa) |
|---|---|
| H13 Bulk | 3.4 |
| Annealed/HRA 54 (benchmark) | |
| As-Received | 8.1 |
| Coarse H13 powder (Lot A) | |
| Coarse H13 powder (Lot A) HT | 3.0 |
| Fine H13 powder (Lot B) HT | ~2.5 |

Powder Characterization:

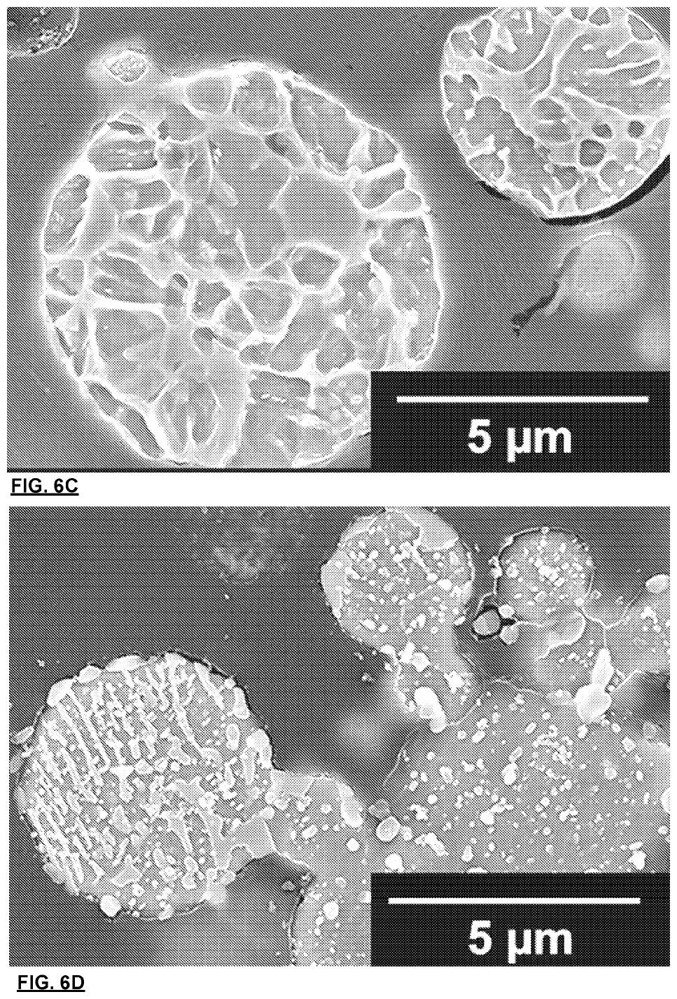

The particle size distributions of the heat treated and as-received H13 powders are shown in FIG. 5 and characterized in Table 2. The powders after HT were sieved with a −45 screen, but no soft grinding was applied. The yield was about 55-80% depending on the batch.

TABLE 2

| | D10 | D50 | D90 |
|---|---|---|---|
| H13 Powder | (μm) | (μm) | (μm) |
| As-Received (Coarse (lot A), −45 μm) | 26.7 | 36.9 | 48.0 |
| Coarse-HT (screened −45 μm) | 27.6 | 36.5 | 46.7 |
| As-Received (Fine (lot B), −16 μm) | 2.8 | 7.0 | 12.6 |
| Fine-HT (screened −45 μm) | 8.7 | 19.8 | 34.8 |

Herein Dx (μm) refers to the particle size value corresponding to x volume percent of the sample having a particle size below or equal to this value. Thus 10% of the coarse lot A powders were about 27 μm or smaller, and heat treating lot A had very little effect on the size distribution. In contrast lot B has a size distribution greatly affected by heat treatment. Much of the finest particles of the as received powders were agglomerated, and so the smallest 10% of the powders by volume went from being about 3 μm or smaller, to about 9 μm or smaller. Given that the volume basis of the percentage biases smaller particles, a large fraction of the number of the particles had been agglomerated.

SEM Powder Characterization:

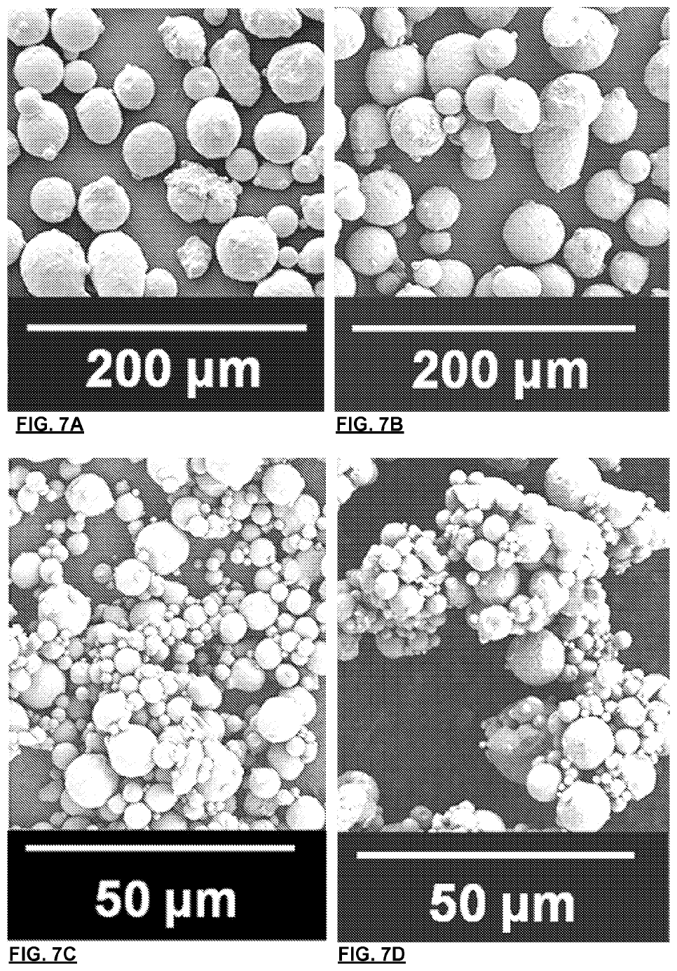

Characterization of the heat treated and as-received H13 powders (coarse and fine lots), with scanning electron microscope, are shown in FIGS. 6 and 7. FIG. 6 show microstructures of different H13 tool steel powders as well as the effect of heat treatment in a rotary furnace. FIG. 6A,B show an as-received H13 powder (lot A) (+10-45 μm) displaying a typical cold spray cut, at two magnifications. The microstructure is composed of dark grains surrounded by a skeletal network of carbides. FIG. 6C presents as-received H13 powder of a finer lot (lot B) (−16 μm) displaying similar microstructure. This finer lot was heat treated, and once agglomerated, was suitable for cold spraying. As shown in FIG. 6D, microstructure of the heat treated powders displays a carbide phase that is spheroidised, which results in a softer powder. Furthermore, inter-particle bonding with well-defined sinter necks is clearly observed, resulting in strong powder agglomeration.

FIG. 7 is a series of micrographs showing coarse powders as-received (FIG. 7A at 250× magnification), and heat treated coarse powders (FIG. 7B at 250× magnification); and fine powders as-received (FIG. 7C at 1000× magnification) and heat treated (FIG. 7D at 1000× magnification). FIGS. 7A,B appear substantially identical. FIGS. 7C,D may seem similar in some areas because of the loose agglomeration of the particles, but the partial sintering of the particles in FIG. 7D resulted in larger particles. The size and arrangement of subparticles suggest how soft grinding can comminute larger particles without exposing the particle to extensive cold working.

Cold Sprayability of H13 Powders:

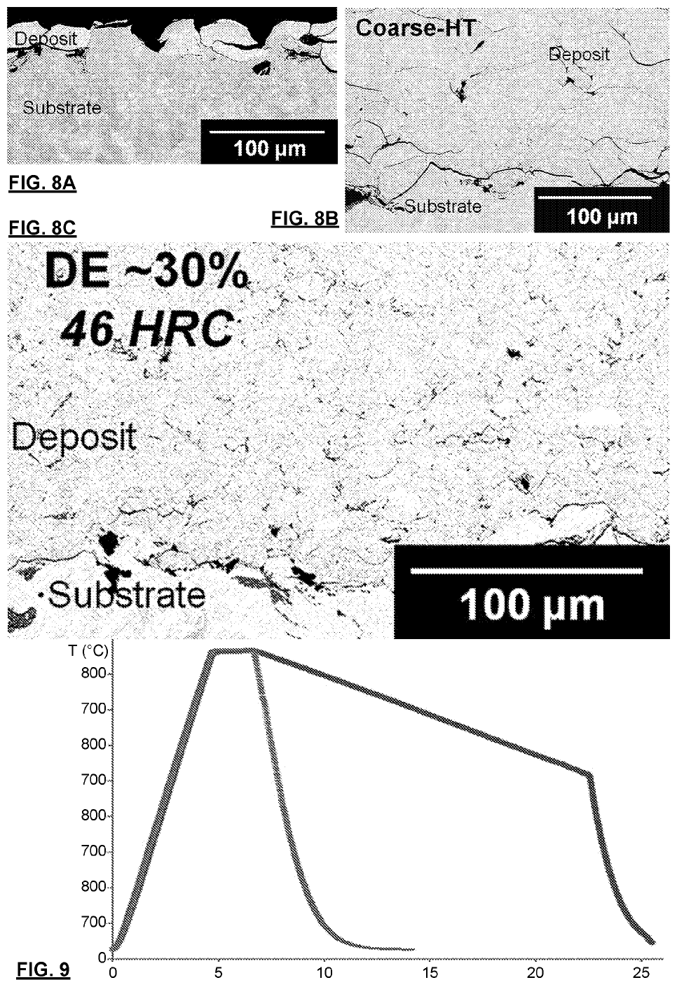

FIG. 8 are micrograph images of results of cold spray of various powders using the same spray parameters. FIG. 8A shows that only a partial monolayer is formed when spraying as-received powder lot A (coarse+10-45 μm) powder. The surface roughness shows that the powders peened the surface and appear poorly bonded to the substrate. HT lot A powders produce a coating, but the coating presented substantial cracks (FIG. 8B). HT lot B powders, as shown in FIG. 8C, produced a thick and sound coating. Coatings as thick as 4 mm have been produced and greater thicknesses may be achieved if desired. The deposition efficiency for the fine heat treated powder was about 30%, which was nearly twice that of HT lot A powder (as received lot A had very low deposition efficiency.

A Rockwell C hardness (HRC, ASTM E18) for the coating produced with the HT lot B powder was found to be 46.

It is known in the art to further heat treat such coatings to tailor microstructure, hardness, and other mechanical properties to the properties required in service. For example it is known to anneal, quench and temper such coatings. Furthermore the additive manufacture of parts using these powders is contemplated, as opposed to simple coatings.

Cooling Rates:

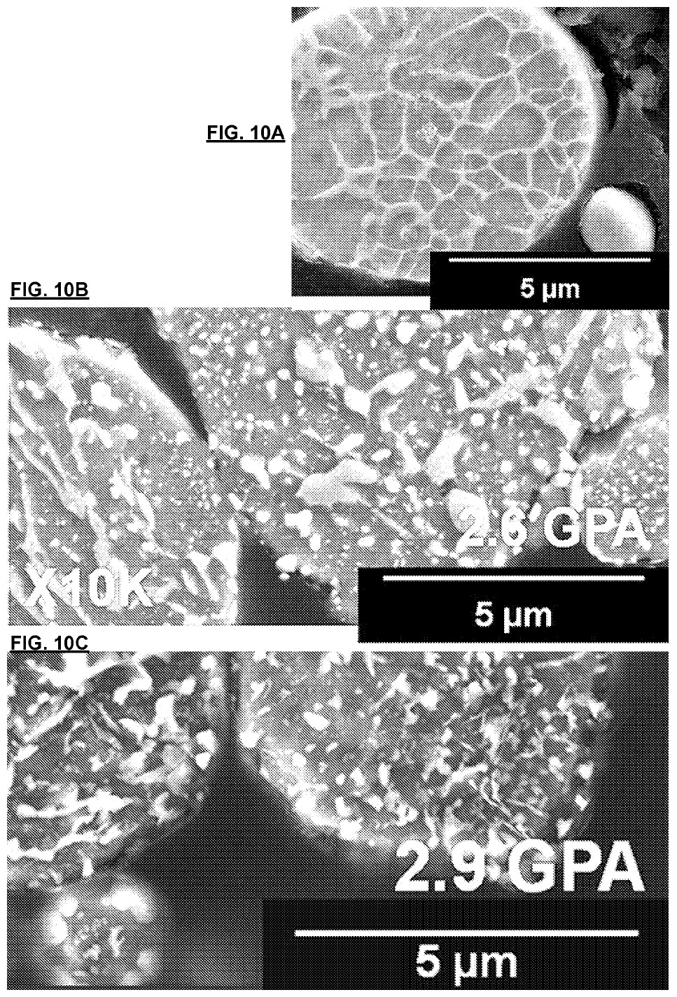

FIG. 9 shows the two cooling rates of the heat treatments that were tested on the powders. While several intermediate regimens were examined, all of the regimens produced nearly equal quality cold spray coatings. Further study with shorter heating and cooling phases for this particular steel powder is expected to show advantages of heat treatment within 8 h or less. FIG. 10 is a series of micrographs showing the effect of these cooling rates on the powder microstructure at 10,000× magnification. FIG. 10A shows as-received gas atomized fine H13 powder, with its highly connected carbide skeletal network. FIG. 10B shows the HT lot B powders cooled after heat treatment at a rate of 22° C./hr (HT lot B-a), and FIG. 10C shows the HT lot B powders cooled after heat treatment at a rate of cooled at a rate of 350° C./hr (HT lot B-b). Unexpectedly both powders show similar spheroidal carbide precipitates and sintering.

The HT lot B powders were sieved and soft ground using a V-blender. Particles greater than 45 μm are subject to soft grinding using a V-blender or a Turbula blender. The output was recycled back to the sieving step up to three times. Soft grinding and sieving has been observed to improve yield from about 55-80% to greater than 90%.

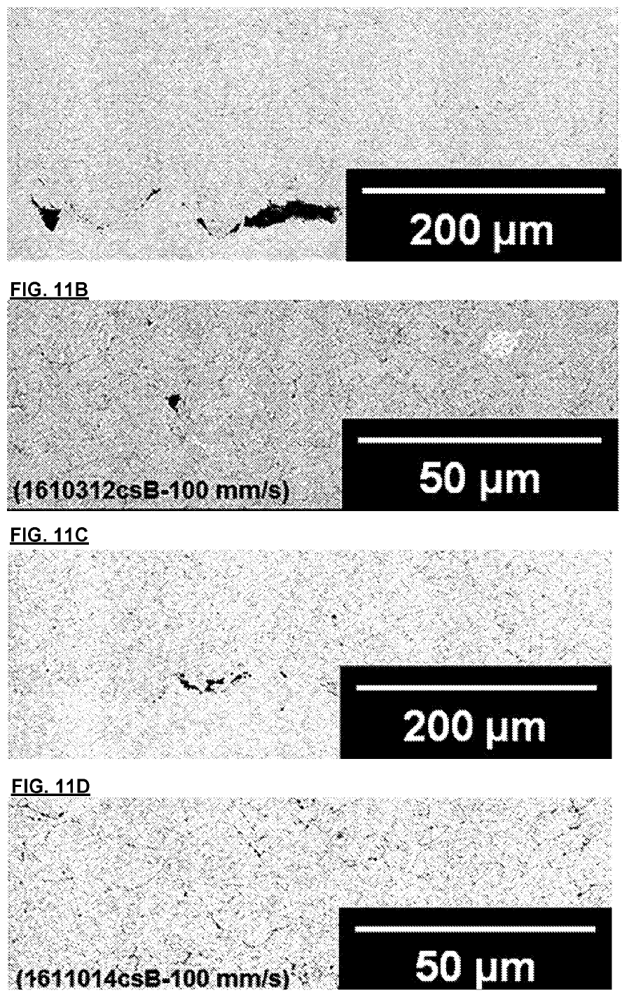

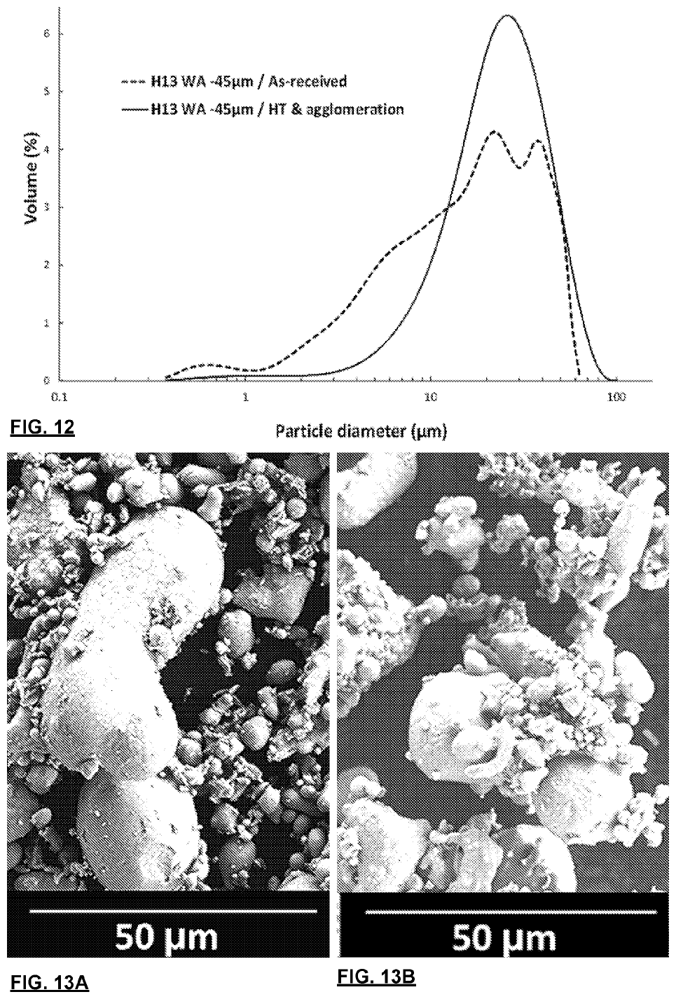

The soft ground HT lot B-a,b powders were sprayed on a P20 stainless steel substrate, as shown in FIG. 11, using a plasma Giken (PCS-1000) spray gun under the following conditions: Tᵢ(N2)=950° C., Pᵢ(N2)=4.9 MPa, Stand-off=45 mm, robot speed: 100 mm/s, Powder feed rate: 3 kg/h, Step size: 1 mm. FIG. 11 is a series of images showing the effect of these cooling rates on cold spray deposits. FIGS. 11A,B are two magnifications of the coatings produced from the soft ground HT lot B-a powders, and FIGS. 11C,D are corresponding magnifications of the coatings from lot B-b powders. The coating integrity is excellent in either case.

### Example 2: H13 Water Atomized Tool Steel Powder

Water atomized powder has a much less regular shape than gas atomized powder with the spherical shape used in examples 1 and 2. Preliminary cold spray trials failed to produce coating with as-received water atomized H13 powders (WA-H13).

Methodology:

−45 μm un-annealed WA-H13 powder from AMC Advanced Powders & Systems, China were subjected to a heat treatment. The heat treatment annealed, softened, and agglomerated (with partial sintering) the powders. The HT was carried out in a rotating tube furnace comprising a 4-inch quartz tube (MTI Corporation Model OFT1200X) under the following conditions: 2.5 rpm, argon atmosphere, 1 kg/batch. During the annealing step, the powders were soaked at 875° C. for 1 hour, then subsequently cooled at a controlled rate of about 350° C./hr until the temperature reached about 500° C. and then allowed to cool freely to room temperature. The HT WA-H13 powders were sieved in a 45 μm sieve of nominal opening (total yield higher than 90%) and subsequently were cold sprayed using these parameters: Plasma Giken PCS1000, Tᵢ(N2)=950° C., Pᵢ(N2)=4.9 MPa, Stand-off=45 mm, robot speed=300 mm/s.

Powder Characterization:

The particle size distributions are shown in FIG. 12, and Vickers micro hardnesses (ASTM E384) of the HT and as received WA-H13 powders and particle size values are shown in Table 3.

TABLE 3

| | D10 | D50 | D90 | Hardness |
|---|---|---|---|---|
| Powder | (μm) | (μm) | (μm) | (10 gf, VHN) |
| As-Received WA-H13 −45 μm | 3.7 | 17.3 | 44.0 | 684 |
| HT WA-H13 (screened −45 μm) | 9.7 | 24.6 | 48.5 | 247 |

The differences in D10 show a large fraction of small powders having agglomerated and a consequent rise of the bottom 10 vol. % of the smallest particles.

SEM Powder Characterization:

as-received and HT WA-H13 powders were imaged with scanning electron microscope, and are shown in FIGS. 11A,B, respectively. FIG. 11B shows considerable agglomeration of fines on the coarser particles.

Cold Sprayability of WA-H13 Modified Powder:

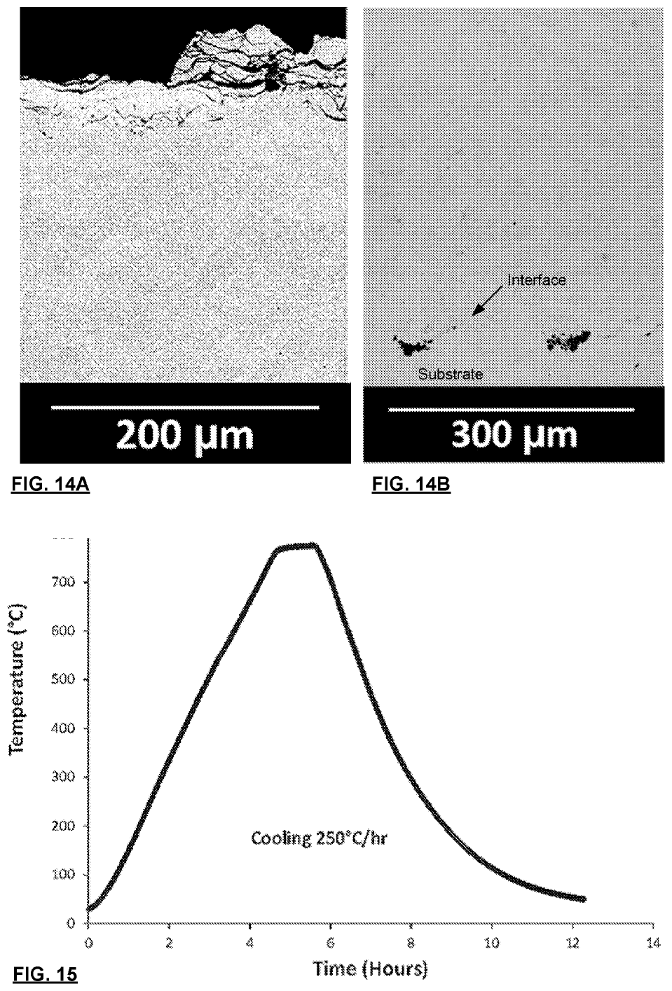

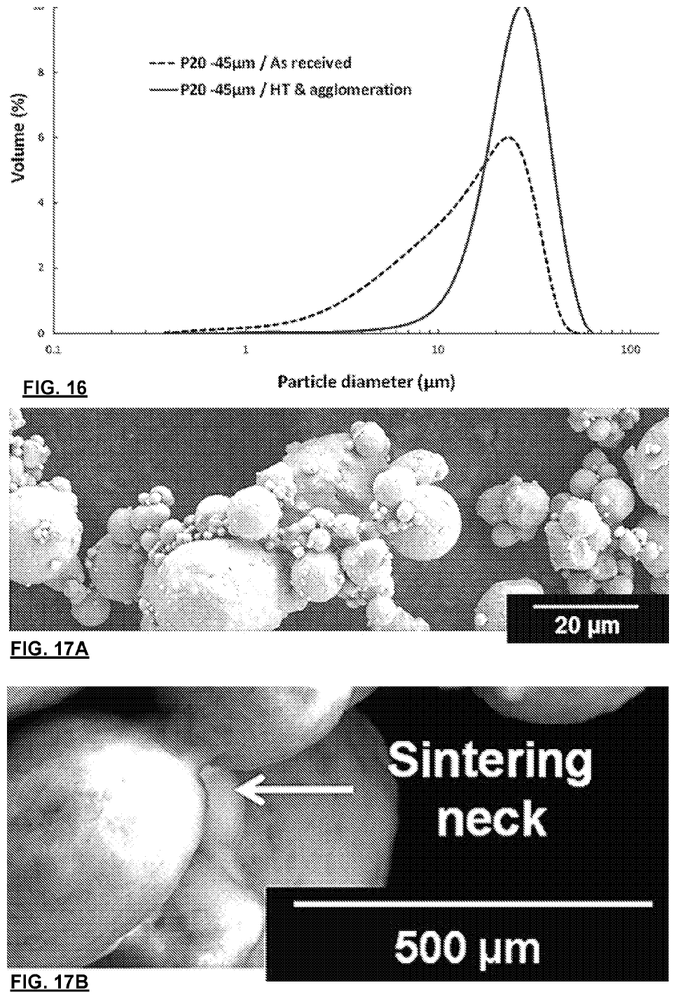

FIG. 14 show results after cold spray deposition using the parameters defined above. A dense coating is obtained with the HT powder, and none is produced with the as-received powder. It can be seen in FIG. 14A that a monolayer coating is obtained using the as-received powder. The as received particles appear poorly bonded to the substrate. On the other hand, as shown in FIG. 14B, a thick and sound coating is obtained using the HT powders. The deposition efficiency for the HT powder was about 70% compared to near 0 for as-received powder.

### Example 3: P20 Tool Steel Powder

Methodology:

The heat treatment in the same device as described above for the H13 tool steel was carried out using P20 tool steel (see FIG. 15 for the temperature regimen). The P20 powders were heated in purified argon in a rotating furnace and were soaked at 775° C. for one hour to allow annealing and agglomeration of fine particles. The powders were cooled at a rate of 250° C./hr. Finally, treated powders were sieved in a 45 μm sieve of nominal opening and a yield greater than 90% was obtained.

Powder Characterization:

The particle size distributions and Vickers micro hardness (modified ASTM E384) of as received and heat treated powders are shown in Table 4 and FIG. 14.

TABLE 4

| | | | | Micro |
|---|---|---|---|---|
| | D10 | D50 | D90 | Hardness |
| Heat Treatment | (μm) | (μm) | (μm) | (3 gf, VHN) |
| As-Received P20 gas | 4.3 | 15.9 | 31.5 | 567 |
| atomized, −45 μm) | | | | |
| Heat-treated P20 gas atomized | 14.9 | 26.7 | 41.3 | 207 |
| (screened −45 μm) | | | | |

The D10 values show a large numerical fraction of the finest powders have agglomerated to produce larger volume powders.

SEM Powder Characterization:

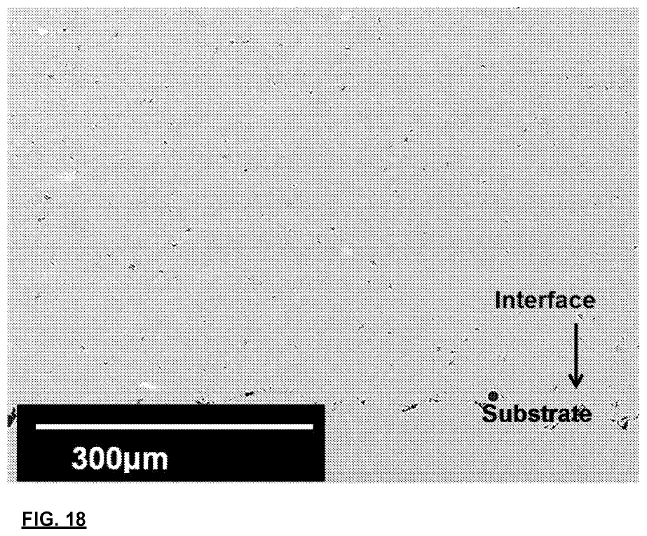

Characterization of the as-received and HT gas atomized P20 powders with scanning electron microscope, is shown respectively in FIGS. 17A,B. Agglomeration of fines on the coarser particles is clearly observed, and a sinter neck is clearly visible in FIG. 17B.

Deposition of Heat Treated P20 Powders:

the P20 powders were deposited using a Plasma Giken (PCS 1000) sprayer under the following conditions: Plasma Giken PCS1000, Tᵢ(N2)=950° C., Pᵢ(N2)=4.9 MPa, Stand-off=45 mm, robot speed=100 mm/s. Several lots were tested and no significant difference between lots was observed, in terms of microstructures and deposition rates. The powders show good reproducibility. The deposition efficiency (DE) was approximately 70%. Produced coatings are dense and free of cracks, as shown in FIG. 18A.

While the above subject matter has been described in the context of heat treatments for specific tool steel powders, it will be appreciated that the heat treatments may also have application to other hard steel metals.

Other examples of suitable transformation hardening steels include low alloy strength steels, martensitic stainless steels and metal matrix composites such as boron nitride reinforced steels.

### Example 4: Simulation Results

Kinetik Spray Solution software was used to simulate effective powder size distribution on deposition efficiency for a range of hard steels. It was found that particle size distribution between 8 and 70 μm provides the most acceptable deposition efficiency for a broad size distribution. Generally, particle size between 30 and 40 μm provide the highest deposition efficiency of the broader distribution. Deposition efficiency decreases drastically with size below 8 μm.

### Example 5: Heat Treatment in Reducing Atmosphere

Applicant has performed heat treatment of H13 powders in a reducing atmosphere consisting of (2.9% H2, balance Ar). Hydrogen is a known oxygen scavenger and is expected to reduce oxidation of the powder, for improved purity.

It will be appreciated by those skilled in the art that although the above alternative embodiments have been described in some detail many modifications may be practiced without departing from the claimed subject matter.

1. A method for preparing a feedstock for cold spray deposition, comprising:
a. obtaining a feedstock powder having a first size distribution, the powder consisting of a transformation hardenable steel, or a metal matrix composite of a transformation hardenable steel;
b. heat treating the powder to a softening temperature of the transformation hardenable steel and holding the powder at the softening temperature while agitating the powder for a time period effective to soften, and to partially sinter, the powder to form powder agglomerates, while avoiding powder caking;
c. cooling the powder agglomerates at a rate sufficiently slowly to avoid re-hardening the material to produce softened powder agglomerates of a second size distribution coarser than the first distribution, the second size distribution having a nominal size less than 150 μm and more than 1 μm; and
d. preventing the softened powder agglomerates from hardening.

2. The method of claim 1 further comprising providing the softened powder agglomerates for use in a cold spray process, or cold spraying the softened powder agglomerates.

3. The method of claim 1 further comprising sieving the softened powder agglomerates to produce the second size distribution.

4. The method of claim 1 further comprising soft grinding to partially de-agglomerate the softened powder agglomerates to increase a yield of the feedstock.

5. The method of claim 4 wherein the soft grinding comprises mixing the softened powder agglomerates in a container so that agglomerated particles of the softened powder agglomerates do not strike any grinding medium bodies harder than the agglomerated particles, and a mean energy of collision is not sufficient to break the agglomerated particles away from sinter necks of the agglomerated particles.

6. The method of claim 5 wherein the soft grinding uses a V-blender with no grinding medium or bodies having a hardness greater than that of agglomerated particles of the softened powder agglomerates.

7. The method of claim 1 where protecting the softened powder agglomerates from hardening comprises preventing cold working and re-transformation hardening prior to cold spray deposition by preventing collision of the agglomerated particles with a body having a hardness greater than that of the aqglomerated particles, if the collision applies a local stress exceeding a yield stress of the agglomerated particles.

8. (canceled)

9. The method of claim 1 with the first size distribution having 90% of the volume fraction of particles below 70 μm and 10% of the volume fraction of particles finer than 20 μm.

10. (canceled)

11. (canceled)

12. The method of claim 1 wherein the heat treatment agglomerates small particles such that the second size distribution has less than half of the volume fraction of particles below 8 μm in the first size distribution.

13. The method of claim 1, wherein the transformation hardenable steel is a tool steel.

14. The method of claim 13 wherein the tool steel is H13 tool steel, and the softening temperature is approximately between 800° and 900° C.

15. (canceled)

16. The method of claim 14, wherein the cooling rate is slow enough to prevent formation of martensite as per the isothermal transformation diagram of H13.

17. The method of claim 13, wherein the tool steel is P20 tool steel and the softening temperature is approximately between 750° and 800° C.

18. (canceled)

19. The method of claim 17, wherein the cooling rate is slow enough to prevent formation of martensite as per the isothermal transformation diagram of P20.

20. The method of claim 1, wherein the heat treatment is performed in an inert or reducing atmosphere.

21. (canceled)

22. The method of claim 1, further comprising:
e. applying the softened powder agglomerates to a substrate by a cold spray process to form a surface layer;
f. evaluating an integrity of the surface layer by physical testing and/or microscopic inspection; and
g. if the integrity of the surface layer is unsatisfactory, adjusting at least one of the softening temperature, the time period, or the cooling rate, and repeating at least steps a-f until the integrity of the surface layer is satisfactory.

23. (canceled)

24. A heat treated feedstock powder for cold spray deposition comprising particles: having a size distribution with a nominal size less than 150 μm and more than 1 μm; composed of a transformation hardenable grade of steel, or a metal matrix composite of a transformation hardenable steel; and having a hardness less than 70% of the hardness of said grade of steel if it were fully transformation hardened.

25. The feedstock powder of claim 24 wherein the transformation hardenable steel is a tool steel, a low alloy strength steel, or a martensitic stainless steel, or specifically H13, P20 or D2 tool steels.

26. (canceled)

27. The feedstock powder of claim 24 wherein typical particles display a carbide network that is spheroidised.

28. The feedstock powder of claim 24 wherein the powder has a Vickers micro-hardness less than 50% of the hardness of said grade of steel if it were fully transformation hardened.

29. The feedstock powder of claim 24 wherein the powder has a morphology of sintered subparticles of a distribution of sizes, including at least 10% of the volume fraction of particles consisting of subparticles finer than 20 μm.

30. (canceled)
